(19) United States
(12) Patent Application Publication
(10) Pub. No.: US 2026/0236011 A1
(43) Pub. Date: Aug. 13, 2026

(54) CONTROL DEVICE AND TOOL SYSTEM

(71) Applicant: Panasonic Intellectual Property Management Co., Ltd., Osaka (JP)

(72) Inventors: Takayuki SASAKI, Osaka (JP); Koya JOJIMA, Osaka (JP); Yuta HARA, Osaka (JP)

(21) Appl. No.: 19/153,567

(22) PCT Filed: Jan. 29, 2024
(86) PCT No.: PCT/JP2024/002674

§ 371 Date: Aug. 4, 2025

(30) Foreign Application Priority Data
Feb. 20, 2023 (JP) 2023-024604

(51) Int. Cl. G05B 19/418; B25F 5/00

(52) U.S. Cl. CPC G05B 19/4184; B25F 5/00; G05B 2219/36545

(57) ABSTRACT

A control device includes: a second communications unit receiving result information transmitted from a tool including a first communications unit transmitting the result information that depends on progress of a work; a first storage being a volatile memory; a first storing processor making the first storage store work progress information being information based on the result information and indicative of a state of progress of the work; a regular power supply unit supplied with external power from an external power source through a power line and supplying, using the external power, operating power to the first storage; a detector detecting a sign of an interruption of a supply of the operating power from the regular power supply unit to the first storage; a second storage being a non-volatile memory; and a second storing processor making, when the detector detects the sign, the second storage store the work progress information.

### TECHNICAL FIELD

The present disclosure relates generally to control devices and tool systems. The present disclosure relates more specifically to a control device configured to communicate with a tool, and a tool system including the control device.

### BACKGROUND ART

Patent Literature 1 describes a power tool control system.

The power tool control system of Patent Literature 1 includes: a center device configured to transmit screw tightening information, which is preset, to a power tool via a network; and the power tool configured to control rotation of a motor based on the screw tightening information received.

### CITATION LIST

### Patent Literature

Patent Literature 1: JP 2000-334670 A

### SUMMARY OF INVENTION

The present disclosure is aimed to improve the usability.

A control device according to one aspect of the present disclosure includes a second communications unit, a first storage, a first storing processor, a regular power supply unit, a detector, a second storage, and a second storing processor. The second communications unit is configured to receive result information transmitted from a tool. The tool includes a first communications unit configured to transmit the result information that depends on progress of a work. The first storage is a volatile memory. The first storing processor is configured to make the first storage store work progress information. The work progress information is information based on the result information and indicative of a state of progress of the work. The regular power supply unit is configured to be supplied with external power from an external power source through a power line and to supply, using the external power, operating power to the first storage. The detector is configured to detect a sign of an interruption of a supply of the operating power from the regular power supply unit to the first storage. The second storage is a non-volatile memory. The second storing processor is configured to, when the detector detects the sign, make the second storage store the work progress information.

A tool system according to one aspect of the present disclosure includes the control device and the tool.

### BRIEF DESCRIPTION OF DRAWINGS

FIG. 1 is a schematic view of a configuration of a tool system according to an embodiment.

FIG. 2 is a block diagram showing a configuration of the tool system.

FIG. 3 FIG. 3A is a perspective view of a tool included in the tool system as viewed from the front side. FIG. 3B is a perspective view of the tool as viewed from the rear side.

FIG. 4 is a sequential diagram for a first operational example of the tool system.

FIG. 5 is a sequential diagram for a second operational example of the tool system.

FIG. 6 is a sequential diagram for a third operational example of the tool system.

FIG. 7 is a continuation of the sequential diagram for the third operational example.

FIG. 8 is a sequential diagram for an operational example of a tool system according to a first variation.

FIG. 9 is a continuation of the sequential diagram for the operational example.

### DESCRIPTION OF EMBODIMENTS

Embodiments of the present disclosure will now be described in detail with reference to the accompanying drawings. In the following description, same reference signs are assigned to the elements which are common in the various embodiments, and redundant explanations for the common elements may be omitted. Note that the embodiments to be described below is only an exemplary one of various embodiments of the present disclosure and should not be construed as limiting. The embodiments may be readily modified in various manners depending on a design choice or any other factor as long as the advantages of the present disclosure are achievable. The drawings to be referred to according to the present disclosure are all schematic representations. That is to say, the ratio of the dimensions (including thicknesses) of respective constituent elements illustrated on the drawings does not always reflect their actual dimensional ratio.

### (1) Overview

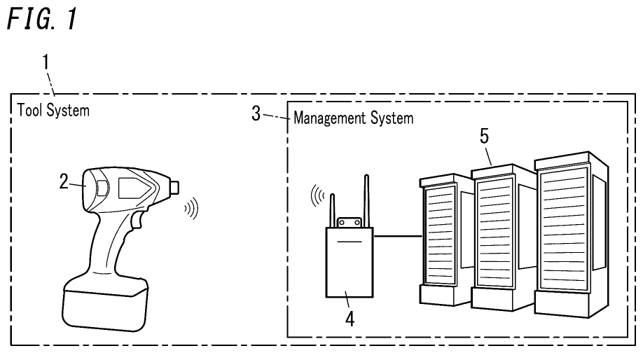

As shown in FIG. 1, a tool system 1 of the present embodiment includes a tool 2, and a management system 3 including a control device 4. The control device 4 and the tool 2 are configured to communicate wirelessly with each other.

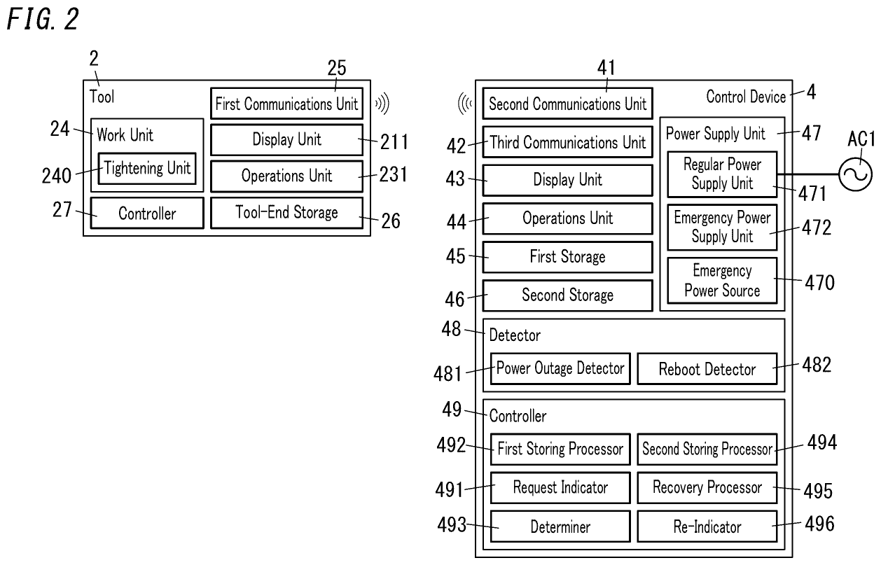

The tool 2 is a portable type power tool, and may be an impact wrench for example. As shown in FIG. 2, the tool 2 includes a work unit 24 and a first communications unit 25.

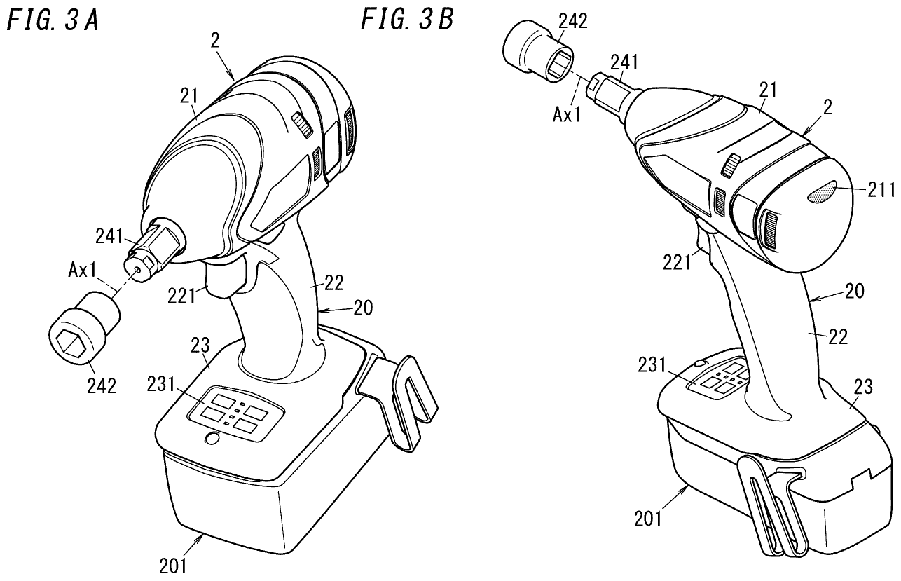

The work unit 24 is configured to perform a predetermined work operation. The work unit 24 includes a tightening unit 240, for example. The tightening unit 240 is configured to rotate a tip tool such as a socket 242 (see FIGS. 3A and 3B) and to thereby perform a tightening operation (work operation) to tighten a fastener such as a bolt.

The first communications unit 25 includes a communications interface for performing the wireless communication with the control device 4. The first communications unit 25 is configured to transmit, to the control device 4, result information that depends on the progress of the work performed by the work unit 24. According to the present disclosure, the “result information” indicates information indicative of a result of a single (one time) work operation (tightening operation) performed by the tool 2.

The management system 3 is a system for managing the work performed using the tool 2. In the present embodiment, the management system 3 is configured to receive the result information from the tool 2 to manage the work performed using the tool 2.

As shown in FIG. 1, the management system 3 includes the control device 4 and a master device 5.

As shown in FIG. 2, the control device 4 includes a second communications unit 41, a first storage 45, a second storage 46, a power supply unit 47, a detector 48, a first storing processor 492, and a second storing processor 494.

The first storage 45 is a volatile memory. The volatile memory indicates a memory that cannot retain the stored information when the supply of the power to the memory is interrupted.

The second storage 46 is a non-volatile memory. The non-volatile memory indicates a memory that can retain the stored information even when the power is not supplied to the memory. Examples of the non-volatile memory include a non-volatile storage.

The second communications unit 41 includes a communications interface for performing the wireless communication with (the first communications unit 25 of) the tool 2. The second communications unit 41 is configured to receive the result information transmitted from the tool 2.

The first storing processor 492 is configured to make the first storage 45 store the work progress information. According to the present disclosure, the “work progress information” indicates information based on the result information received from the tool 2 and indicative of a state of progress of the work. The “work progress information” may be the result information received from the tool 2 itself, or may be information obtained by subjecting some processing on the result information. According to the present disclosure, the “work” includes a series of multiple work operations. The “state of progress of the work” indicates information indicative of what is an ordinal number of work operation that has just finished among the series of multiple work operations.

As described above, the first storage 45 is a volatile memory and thus cannot retain the information when the supply of the power (operating power) to the memory is interrupted. In the control device 4, the operating power of the first storage 45 is supplied from the power supply unit 47.

The power supply unit 47 includes a regular power supply unit 471. External power is supplied from an external power source AC1 to the regular power supply unit 471 through a power line. The regular power supply unit 471 is configured to supply the operating power to the first storage 45 using the external power.

The detector 48 is configured to detect a sign of an interruption of a supply of the operating power from the regular power supply unit 471 to the first storage 45. According to the present disclosure, the “sign of an interruption of a supply of the operating power from the regular power supply unit 471 to the first storage 45” is an event indicating that the supply of the operating power from the regular power supply unit 471 to the first storage 45 will be interrupted after a predetermined time.

The second storing processor 494 is configured to, when the detector 48 detects the sign (i.e., the sign of the interruption of the supply of the operating power from the regular power supply unit 471 to the first storage 45), make the second storage 46 store the work progress information.

According to the control device 4 of the present embodiment, the work progress information is stored in the second storage 46 when an event occurs indicating that the supply of the operating power from the regular power supply unit 471 to the first storage 45 will be interrupted. This can avoid the work progress information from being lost even when the first storage 45 cannot retain the work progress information any more due to the interruption of the supply of the operating power. Moreover, at normal times, the work progress information is stored in the first storage 45, which is the volatile memory. This can extend the service life of the second storage 46 as the non-volatile memory, which usually has a short service life compared to the volatile memory.

Accordingly, the control device 4, and the tool system 1 of the present embodiment including the same can provide the improved usability.

### (2) Details

Hereinafter, details of the control device 4 and the tool system 1 of the present embodiment are described with reference to FIGS. 1 to 7.

### (2.1) Overall Configuration

As shown in FIG. 1, the tool system 1 includes the tool 2 and the management system 3. Optionally, the tool system 1 may include a plurality of tools 2. As described above, the tool 2 and the management system 3 (control device 4) are configured to communicate wirelessly with each other.

The tool system 1 of the present embodiment may be used, for example, in an assembly line in a factory where a user(s) (worker(s)) performs the work for assembling the work target (such as electric products, furniture, or the like). The tool 2 is a power tool such as an impact wrench as described above, for example, and is to be used for tightening fasteners (such as screws, bolts, and nuts). However, the tool system 1 is not limited to be used in the assembly line.

### (2.2) Tool

As shown in FIG. 2, the tool 2 includes the work unit 24, the first communications unit 25, a tool-end storage 26, a controller 27, a display unit 211, and an operations unit 231. The work unit 24 includes the tightening unit 240 for tightening the fastener. In the present embodiment, the tool 2 includes, as a constituent element thereof, a battery pack 201 (see FIG. 3A). However, the battery pack 201 is not necessarily the constituent element of the tool 2. That is, the battery pack 201 may not be the constituent element of the tool 2. The battery pack 201 may be a separate member from the tool 2 (tool body) and be detachably attached to the tool 2 (tool body), for example.

As shown in FIGS. 3A and 3B, the tool 2 further includes a body 20. The body 20 of the tool 2 includes a barrel part 21, a grip part 22, and an attachment part 23.

The barrel part 21 is formed in a tube shape (cylindrical tube shape, in the embodiment). The grip part 22 protrudes in one direction (downward, in FIG. 3A) from a part of a peripheral surface of the barrel part 21. The attachment part 23 is configured such that the battery pack 201 is detachably attached to the attachment part 23. The attachment part 23 is provided at an end of the grip part 22. In other words, the barrel part 21 and the attachment part 23 are coupled together via the grip part 22.

At least part of the tightening unit 240 (see FIG. 2) is housed in the barrel part 21. An output shaft 241 of the tightening unit 240 protrudes outward from one end surface in an axial direction of the barrel part 21.

The grip part 22 is to be gripped by a user when he/she performs the work. A trigger switch 221 is provided to the grip part 22. The trigger switch 221 is a switch for controlling the operation of the tightening unit 240 to be switched between on and off. The trigger switch 221 has an initial position and an on-position. When the trigger switch 221 is pulled or pushed by the user to the on-position, the tightening unit 240 is activated. Moreover, a rotation speed of a motor of the tightening unit 240 can be controlled by controlling the pulled amount (operation amount) of the trigger switch 221.

The attachment part 23 is formed in a flat rectangular parallelepiped shape. The battery pack 201 is detachably attached to a face of the attachment part 23 opposite to the grip part 22.

The battery pack 201 includes a lithium ion battery, for example. The battery pack 201 supplies electricity to the work unit 24, the first communications unit 25, the tool-end storage 26, the controller 27 and the like.

The attachment part 23 is provided with the operations unit 231. By the operations unit 231, status of the tool 2 can be checked and various settings of the tool 2 can be configured. The user can, for example, check the battery level of the battery pack 201 by operating the operations unit 231.

The display unit 211 includes a light emitting diode(s) (LED), for example. The display unit 211 is provided at an end (rear end) of the barrel part 21 of the body 20 opposite to the output shaft 241, allowing the user to see the display unit 211 easily during the work. The display unit 211 can emit lights of various colors, thereby providing various information (e.g., the tool is performing the tightening operation, a replacement time of a component is near, and the like) to the user.

The tightening unit 240 includes the motor, a speed reducer mechanism, a drive shaft, an impact mechanism, the output shaft 241, and the socket 242. The tightening unit 240 is configured to operate with power supplied from the battery pack 201 to the motor. The tightening unit 240 is configured to tighten a fastener by rotating the tip tool (socket 242) with the drive force of the motor. It should be noted that the socket 242 is not necessarily a constituent element of the tightening unit 240. That is, the socket 242 may not be the constituent element of the tightening unit 240.

The speed reducer mechanism is configured to transfer the rotational force of the rotation shaft of the motor to the driving shaft. The speed reducer mechanism may include, for example, a planetary gear mechanism and convert the rotation speed of and the torque provided by the rotation shaft of the motor into the rotation speed and the torque required for the tightening operation. The output shaft 241 receives the rotational force of the driving shaft to transfer it to the socket 242. The output shaft 241 rotates around a rotation axis Ax1 along a protruding direction of the output shaft 241. That is, the tightening unit 240 is configured to drive the output shaft 241 to rotate the output shaft 241 around the rotation axis Ax1. In other words, by the operation of the tightening unit 240, the torque is applied to the output shaft 241 and the output shaft 241 rotates.

To the output shaft 241, the socket 242 having a circular tube shape is detachably attached for rotating the fastener (e.g., bolt or nut). The socket 242 rotates along with the output shaft 241 around the axis of the output shaft 241. The size of the socket 242 to be attached to the output shaft 241 can be appropriately selected by the user, according to the size of the fastener. According to this configuration, by the operation of the tightening unit 240, the output shaft 241 rotates and thus the socket 242 rotates along with the output shaft 241. When the socket 242 is fitted to the fastener, the fastener rotates along with the socket 242 to realize the tightening operation to tighten the fastener. Accordingly, the tool 2 can realize the operation to tighten the fastener by the operation of the tightening unit 240.

Alternatively, a socket anvil chuck may be attached to the output shaft 241 in place of the socket 242. The socket anvil chuck is also detachably attached to the output shaft 241. In this case, a tool bit (such as a driver bit or a drill bit) can be attached with the socket anvil chuck.

The impact mechanism is configured to be driven by a motive power of the motor. The impact mechanism includes a hammer rotatably held by the drive shaft, and an anvil provided at a rear end of the output shaft 241. The hammer strikes the anvil according to the rotation of the drive shaft. The impact mechanism provides the impact along the rotational direction against the output shaft 241 when the tightening torque exceeds a predetermined level. The tool 2 accordingly can provide a more greater tightening torque to the fastener. Alternatively, the tightening unit 240 may not include the impact mechanism.

The first communications unit 25 includes a communications interface configured to perform the wireless communication with the control device 4 (of the management system 3). The first communications unit 25 is configured to communicate with the control device 4 under a wireless communications scheme compliant with the standard of Wi-Fi (registered trademark), Bluetooth (registered trademark), ZigBee (registered trademark), or license-free low power radio (specified low power radio), for example.

The first communications unit 25 is configured to receive a work request from the control device 4. According to the present disclosure, the “work request” indicates information indicative of contents of the work to be performed by the tool 2. The “work request” contains information about multiple work operations (tightening operations) contained in the work to be performed by the tool 2, and information about a work parameter with which the tool 2 operates when the tool 2 performs each of the multiple work operations. Examples of the “information about multiple work operations” include number of work information indicative of the number of the fasteners on each of which the tool 2 performs the tightening operation (work operation) (i.e., the number of tightening operations to be performed by the tool). Examples of the “information about a work parameter” include parameter information indicative of target torque values for respective tightening operations. That is, the “work request” contains the number of work information indicative of the number of the fasteners on each of which the tool 2 performs the tightening operation, and the parameter information indicative of the target torque value for the tightening operation. Optionally, the “work request” may include location information indicative of a location of the fastener where the tool 2 performs the tightening operation, procedure information indicative of the order for performing the multiple tightening operations, or the like.

The first communications unit 25 is configured to transmit, to the control device 4 of the management system 3, the result information that depends on the progress of the work, under the control of the controller 27. Specifically, the first communications unit 25 transmits, every time the tightening unit 240 performs the tightening operation, the result information corresponding to the tightening operation performed.

As described above, the “result information” is information indicative of a result of a single work operation (tightening operation) performed by the tool 2. The “result information” contains work number information indicative of the work number, and a result detain indicative of a result of the work operation, for example.

According to the present disclosure, the “work number” indicates an ordinal number of the work operation that has just performed by the tightening unit 240 among the multiple work operations designated by the “work request”. In an exemplary case where the tightening unit 240 tightens three fasteners (i.e., performs the tightening operations three times), the work number of the tightening operation performed first is “1”, the work number of the tightening operation performed second is “2”, and the work number of the tightening operation performed third is “3”. Therefore, the result information transmitted after the tool 2 performs the third tightening operation contains the work number information indicating “3” that corresponds to the latest work number. In short, the result information contains the work number which indicates what is an ordinal number of work operation that has just finished among the multiple work operations. According to the embodiment, the work number is represented by the numerical number, but is not limited thereto. Alternatively, the work number may be an identifier indicative of the ordinal number of work operation that has just finished among the multiple work operations.

Examples of the result detail include the magnitude of the tightening torque provided to the fastener during the tightening operation, a determination result whether the tightening operation is correctly performed (e.g., OK or NG), a reason why the tightening operation is NG, and the like.

The first communications unit 25 is configured to, when a state of the wireless communication with the control device 4 recovers from the communication disable state to the communication enable state, transmit current status information to the control device 4. The “current status information” is information indicative of how far the work performed by the tool 2 goes. The current status information is information indicative of the work number corresponding to the latest tightening operation performed by the tool 2, for example. In an exemplary case where the tool 2 has performed the tightening operations three times, the current status information is information indicating “3” as the latest work number. Namely, the current status information contains the “work number information” but does not contain the “result detail”, among the information contained in the result information transmitted last time. However, this is only an example and should not be construed as limiting. Alternatively, the current status information may contain the “result detail”.

The first communications unit 25 is configured to, when the state of the wireless communication with the control device 4 recovers, detect the recovery and voluntary transmit the current status information. However, this is only an example and should not be construed as limiting. Alternatively, the first communications unit 25 is configured to, when the state of the wireless communication with the control device 4 recovers, receive a request from the control device 4 and transmit the current status information.

The tool-end storage 26 includes a semiconductor memory such as a Read Only Memory (ROM), Random Access Memory (RAM), and Electrically Erasable Programmable Read Only Memory (EEPROM). The tool-end storage 26 is not limited to the semiconductor memory, but may include a hard disc drive or the like

The tool-end storage 26 stores the result information (combination of the work number information and the result detail) about the respective work operations (tightening operations) performed by the tightening unit 240. The tool-end storage 26 also stores the current status information. The result information and the current status information may be deleted by the controller 27 in response to work completion information transmitted from the control device 4 after completion of the work performed by the tool 2, for example.

The controller 27 includes, as a main component, a computer system including one or more processors and one or more memories, for example. The tool 2 performs the function of the controller 27 by making the one or more processors execute a program stored in the memory. The program may be stored in advance in the memory, downloaded via a telecommunications line such as the Internet, or distributed after having been stored in a non-transitory storage medium such as a memory card.

The controller 27 controls the operations of the work unit 24, the first communications unit 25, the tool-end storage 26, and the display unit 211.

The controller 27 controls the tightening unit 240 such that the tightening torque by the tightening operation reaches the target torque value defined in the work request received by the first communications unit 25. For example, the controller 27 has a torque estimation function for estimating the magnitude of the tightening torque. In an example, until the estimated value of the tightening torque reaches a seating determination level, the controller 27 estimates the magnitude of the tightening torque on the basis of the rotation speed (of the motor) of the tightening unit 240. After the estimated value of the tightening torque reaches the seating determination level, the controller 27 estimates the magnitude of the tightening torque on the basis of the number of impacts made by the impact mechanism. When the number of impacts made by the impact mechanism reaches a threshold value that depends on the target torque value, the controller 27 determines that the tightening torque reaches the target torque value and stops the operation of (the motor of) the tightening unit 240. Accordingly, the tool 2 can tighten the fastener with the tightening torque of the target torque value.

The controller 27 is configured to, every time the tightening unit 240 performs the tightening operation, make the tool-end storage 26 store the result information corresponding to the tightening operation performed. Also, the controller 27 is configured to, every time the tightening unit 240 performs the tightening operation, perform a control to transmit the result information from the first communications unit 25 to the control device 4.

The controller 27 is configured to, when the state of the wireless communication between the first communications unit 25 and the control device 4 recovers from the communication disable state to the communications enable state, perform a control to transmit the current status information from the first communications unit 25 to the control device 4.

### (2.3) Management System

As shown in FIG. 1, the management system 3 includes the control device 4 and the master device 5.

### (2.3.1) Master Device

The master device 5 may be implemented as a Programmable Logic Controller (PLC), a Personal Computer (PC), a server or the like. The master device 5 has a function for performing communications with the control device 4. The communications scheme between the master device 5 and the control device 4 may be compliant with the standard of the wired Local Area Network (LAN) such as the Ethernet (registered trademark), for example. Alternatively, the master device 5 and the control device 4 may communicate wirelessly with each other. Optionally, a single master device 5 may be configured to communicate with two or more control devices 4.

The master device 5 is configured to transmit a work instruction to the control device 4, in accordance with a predetermined setting or operations given by a manager of the assembly line, for example. The “work instruction” is information containing “work requests” to be respectively transmitted to one or more tools 2. The master device 5 further has a function for collectively managing data transmitted from the control device 4. For example, the master device 5 stores the result information transmitted from the control device 4 on the tightening operation basis, thereby managing the history of the tightening operations performed by the tool 2.

### (2.3.2) Control Device

As shown in FIG. 2, the control device 4 includes the second communications unit 41, a third communications unit 42, a display unit 43, an operations unit 44, the first storage 45, the second storage 46, the power supply unit 47, the detector 48, and a controller 49.

The second communications unit 41 includes a communications interface for the wireless communication with (the first communications unit 25 of) the tool 2. As described above, the second communications unit 41 is configured to communicate with the tool 2 with a wireless communications scheme.

The second communications unit 41 is configured to transmit, to the tool 2, the work request on the basis of the work instruction that the third communications unit 42 receives from the master device 5. The second communications unit 41 is configured to receive the result information transmitted from the tool 2.

The second communications unit 41 is configured to receive the current status information transmitted from the tool 2 when the state of the wireless communication with (the first communications unit 25 of) the tool 2 recovers from the communication disable state to the communication enable state.

The third communications unit 42 includes a communications interface for the wired communication with the master device 5. The third communications unit 42 is configured to receive the work instruction from the master device 5.

The third communications unit 42 is configured to, every time the second communications unit 41 receives the result information, transmit the received result information to the master device 5. However, this is only an example and should not be construed as limiting. Alternatively, the third communications unit 42 may regularly (i.e., at regular intervals) transmit the data to the master device 5, may transmit the data to the master device 5 when all the work is completed, or may transmit the data to the master device 5 when requested by the master device 5.

The display unit 43 includes (a) LED(s), for example. The operations unit 44 includes a plurality of push-button switches, for example. If the control device 4 includes a touch screen panel, the touch screen panel may serve as the display unit 43 and the operations unit 44.

The first storage 45 is a volatile memory. The first storage 45 is a Random Access Memory (RAM), for example.

The first storage 45 stores the work instruction that the third communications unit 42 receives from the master device 5. The first storage 45 stores the work request transmitted to the tool 2. The first storage 45 stores the work progress information which is based on the result information that the second communications unit 41 receives from the tool 2.

The second storage 46 is a non-volatile memory. Examples of the second storage 46 include a Read Only Memory (ROM), and a magnetic storage (such as a hard disc drive). The second storage 46 may be a flash memory, for example.

The second storage 46 is configured to store registered tool information about the tool 2 that is managed by the management system 3 (the control device 4), such as the model number, identification information, and the like of the tool 2.

The power supply unit 47 includes the regular power supply unit 471 and an emergency power supply unit 472.

To the regular power supply unit 471, external power is supplied from the external power source AC1 through the power line. The external power source AC1 may be a commercial power supply, and the external power may be an alternative current power of AC100V or AC200V, for example.

The regular power supply unit 471 includes a power cord to be connected to the external power source AC1, or a connection terminal to be connected to a power cord, for example. The regular power supply unit 471 includes a power converter circuit. The power converter circuit may include an AC/DC converter, a DC/DC converter, and the like. The power converter circuit is configured to perform the conversion on the supplied external power to generate the operating power for operating various components of the control device 4 (such as the second communications unit 41, the third communications unit 42, the display unit 43, the operations unit 44, the first storage 45, the second storage 46, and the controller 49). The operating power is supplied from the regular power supply unit 471 to the components of the control device 4. The voltage of the operating power supplied from the regular power supply unit 471 may vary depending on the supply target.

To the emergency power supply unit 472, emergency power is supplied from an emergency power source 470 which is different from the external power source AC1. The emergency power source 470 is a battery, and the emergency power is a direct current power of DC1.5V or DC3V, for example. The battery is a primary battery in the embodiment, but is not limited thereto. Alternatively, the battery may be a secondary battery. The emergency power supply unit 472 includes a connection terminal to be connected to the emergency power source 470, for example. The connection terminal may be provided to a housing box in which the emergency power source 470 (battery) is housed, for example. The emergency power supply unit 472 may include a power converter circuit (such as a DC/DC converter) for performing conversion on the emergency power. According to the embodiment, the emergency power source 470 is not a constituent element of the control device 4. Alternatively, the emergency power source 470 may be a constituent element of the control device 4.

The power supply unit 47 is configured to, when the external power is supplied from the external power source AC1 to the regular power supply unit 471, generate the operating power based on the external power and supply the operating power to the respective components of the control device 4. The power supply unit 47 is configured to, in a case of the power outage where the supply of the external power from the external power source AC1 to the regular power supply unit 471 is interrupted, supply the operating power to the respective components of the control device 4 based on the emergency power of the emergency power source 470. For example, the power supply unit 47 is configured to, when a power outage detector 481 (to be described later) detects the power outage, switch an internal selector switch to thereby switch a supply source of the electric power from the external power source AC1 to the emergency power source 470. The power supply unit 47 may include an electricity storage device such as a capacitor, such that the supply of the operating power can be continued during a time period when the selector switch is switched.

The detector 48 is configured to detect a sign of an interruption of a supply of the operating power from the regular power supply unit 471 to the first storage 45. The detector 48 is configured to detect an occurrence of an event indicating that the supply of the operating power to the first storage 45 will be interrupted after a predetermined time. The predetermined time may be shorter than or equal to 10 seconds, may be shorter than or equal to 5 seconds, or may be shorter than or equal to 1 second, for example.

As shown in FIG. 2, the detector 48 includes the power outage detector 481 and a reboot detector 482.

The power outage detector 481 is configured to detect the power outage. According to the present disclosure, the “power outage” indicates an interruption of the supply of the external power from the external power source AC1 to the regular power supply unit 471. According to the present disclosure, the “power outage” may not be limited to a power failure of the commercial power supply as the external power source AC1, but may include an interruption of the power supply to the control device 4 due to an open circuit occurred inside the factory, an interruption of the power supply to the control device 4 due to a disconnection of a power plug of the control device 4 from the outlet, and an interruption of the power supply to the regular power supply unit 471 due to a short-circuit occurred in the control device 4.

When such a power outage occurs, the external power is not supplied to the regular power supply unit 471, as a result of which the supply of the operating power from the regular power supply unit 471 to the first storage 45 may be interrupted. Thus, the power outage detector 481 detects, as the sign of the interruption of the supply of the operating power from the regular power supply unit 471 to the first storage 45, the power outage (an event that the power outage occurs). The power outage detector 481 may be configured to detect the power outage based on an output of a voltage sensor that detects the voltage applied to the regular power supply unit 471, for example. Alternatively, the power outage detector 481 may be configured to detect the power outage based on a signal informing the occurrence of the power outage, transmitted from an external device such as the master device 5.

The reboot detector 482 is configured to detect a precursor of the reboot of the controller 49 (i.e., a precursor that the controller 49 will be rebooted). When the controller 49 is rebooted, the regular power supply unit 471 temporarily stops generating the operating power, as a result of which the supply of the operating power to the first storage 45 may be interrupted. Thus, the reboot detector 482 detects, as the sign of the interruption of the supply of the operating power from the regular power supply unit 471 to the first storage 45, the precursor of the reboot of the controller 49. According to the present disclosure, the “precursor of the reboot” indicates an event that the controller 49 will reboot with a high possibility within a short time (e.g., within 10 seconds). The “precursor of the reboot” may include a start of an update processing of the program accompanying the reboot of controller 49. The “precursor of the reboot” may include a situation where the controller 49 selects a soft reset to overcome a processing error. The “precursor of the reboot” may include an operation performed on the operations unit 44 that includes the instruction to execute the reboot processing. The “precursor of the reboot” may include a reception of a signal including an instruction to execute the reboot processing from an external device such as the master device 5.

The reboot detector 482 may be implemented as a function of a processor (described later) of the controller 49. The reboot detector 482 may be configured to detect the reboot to be executed along with the update processing of the program of the controller 49, for example. The reboot detector 482 may be configured to detect the reboot to be executed as a result of the processing error of the controller 49. The reboot detector 482 may be configured to detect the reboot to be executed as a result of the operations given to the operations unit 44 of the control device 4.

The controller 49 includes, as a main component, a computer system including one or more processors and one or more memories, for example. The control device 4 performs the function of the controller 49 by making the one or more processors execute a program stored in the memory. The program may be stored in advance in the memory, downloaded via a telecommunications line such as the Internet, or distributed after having been stored in a non-transitory storage medium such as a memory card.

The controller 49 is configured to control operations of the second communications unit 41, the third communications unit 42, the display unit 43, the first storage 45, the second storage 46, and the power supply unit 47.

As shown in FIG. 2, the controller 49 includes a request indicator 491, the first storing processor 492, a determiner 493, the second storing processor 494, a recovery processor 495, and a re-indicator 496.

The request indicator 491 is configured to, based on the work instruction received from the master device 5 through the third communications unit 42 and with reference to the identification information of each tool 2, generate the work request to be transmitted to the tool 2. As described above, the work request contains the number of work information and the parameter information. The request indicator 491 transmits the generated work request to the tool 2 through the second communications unit 41.

The controller 49 is configured to receive the result information from the tool 2 through the second communications unit 41. As described above, the “result information” contains the work number information and the result detail.

The controller 49 is configured to, when receiving the result information from the tool 2, transmit the result information to the master device 5 through the third communications unit 42.

Also, when receiving the result information from the tool 2, the controller 49 generates the work progress information and then the first storing processor 492 makes the first storage 45 store the work progress information. The work progress information is information based on the result information received from the tool 2. In the present embodiment, the work progress information contains: the number of work information (e.g., the number of fasteners on which the tool 2 performs the tightening operation) and the parameter information (e.g., target torque value of the tightening operation) contained in the work request that has been transmitted; and the work number information (latest work number) contained in the result information.

Suppose an exemplary case where the work request is information requesting to perform the tightening operations three times. In this case, if no result information is received from the tool 2, the work number of the work progress information stored in the first storage 45 should be “0”. When receiving from the tool 2 the result information containing the work number “1”, the first storing processor 492 changes the work number of the work progress information stored in the first storage 45 into “1” (e.g., generates the renewed work progress information and stores it on the first storage 45). Also, when receiving from the tool 2 the result information containing the work number “2”, the first storing processor 492 changes the work number of the work progress information stored in the first storage 45 into “2”. When receiving from the tool 2 the result information containing the work number “3”, the first storing processor 492 changes the work number of the work progress information stored in the first storage 45 into “3” The determiner 493 determines, based on the work progress information, whether the work performed by the tool 2 is completed. According to the present embodiment, the “work (to be) performed by the tool 2” indicates the “multiple work operations (tightening operations)” contained in the work request.

In the exemplary case where the work request is information requesting to perform the tightening operations three times, the determiner 493 determines that the work is not completed when the work number of the work progress information is “0”, “1”, or “2”. When the work number of the work progress information is “3” in this case, the determiner 493 determines that the work performed by the tool 2 is completed. When determining that the work performed by the tool 2 is completed, the determiner 493 transmits the work completion information from the second communications unit 41 to the tool 2.

The second storing processor 494 is configured to, when the detector 48 detects the sign of the interruption of the supply of the operating power from the regular power supply unit 471 to the first storage 45, make the second storage 46 store the work progress information (i.e., write the work progress information into the second storage 46). In the present embodiment, the second storing processor 494 reads out the work progress information from the first storage 45, and makes the second storage 46 store the work progress information thus read out.

When the “sign” is the power outage, the supply of the external power from the external power source AC1 is interrupted. Thus, when the power outage detector 481 detects the power outage, the controller 49 (the second storing processor 494) operates with the emergency power and makes the second storage 46 store the work progress information.

On the other hand, when the “sign” is the precursor of the reboot, the external power is continuously supplied. Thus, when the reboot detector 482 detects the precursor of the reboot, the controller 49 (the second storing processor 494) can operate with the external power and makes the second storage 46 store the work progress information. However, this is only an example and should not be construed as limiting. Alternatively, even when the sign is the precursor of the reboot, the controller 49 (the second storing processor 494) may operate with the emergency power and make the second storage 46 store the work progress information. In short, the second storing processor 494 is configured to, when the reboot detector 482 detects the precursor of the reboot, make the second storage 46 store the work progress information.

It should be noted that in the case where the “sign” is the power outage particularly, the control device 4 may restrict the supply target to which the operating power is supplied from the power supply unit 47 to reduce the consumption of the emergency power of the emergency power source 470, in order to avoid the situation where the second storing processor 494 cannot complete the processing due to. e.g., the shortage of the emergency power. In the case where the sign is the power outage, the control device 4 may stop the supply of the power to the second communications unit 41, the third communications unit 42, and the display unit 43, for example. The supply of the power to the second communications unit 41, the third communications unit 42, and the display unit 43 may be stopped before the second storing processor 494 performs the processing to make the second storage 46 store the work progress information, for example. That is, the emergency power supply unit 472 may be configured to, before the second storing processor 494 performs the processing to make the second storage 46 store the work progress information, stop supplying the operating power to the second communications unit 41. Note that even in the case where the sign is the precursor of the reboot, the power supply unit 47 (the regular power supply unit 471 or the emergency power supply unit 472) may, before the second storing processor 494 performs the processing to make the second storage 46 store the work progress information, stop supplying the operating power to the second communications unit 41.

After the detector 48 detects the “sign”, the supply of the operating power to the first storage 45 is interrupted, by the outage of the emergency power when the “sign” is the power outage, or by the execution of the reboot processing when the “sign” is the precursor of the reboot. When the supply of the operating power is stopped, the work progress information stored in the first storage 45 may be deleted. Moreover, the communication connection between the tool 2 and the control device 4 is lost, since the supply of the operating power to the second communications unit 41 is stopped.

The recovery processor 495 is configured to execute a recovery processing.

The recovery processor 495 is configured to detect a resumption of the supply of the operating power to the first storage 45 during the recovery processing.

The recovery processor 495 is configured to detect the resumption of the supply of the operating power to the first storage 45 by detecting the recovery from the power outage (restoration of power), for example. The recovery processor 495 may be configured to detect the restoration of power when the controller 49 restarts the operation, for example. The recovery processor 495 may be configured to detect the restoration of power by detecting, by a voltage sensor, the voltage applied to the regular power supply unit 471, for example.

The recovery processor 495 is configured to detect the resumption of the supply of the operating power to the first storage 45 by detecting a completion of the reboot of the controller 49. Since the recovery processor 495 is implemented as a function of the controller 49, the controller 49 can detect the completion of the reboot.

According to the recovery processing, when detecting the resumption of the supply of the operating power to the first storage 45, the recovery processor 495 reads out the work progress information stored in the second storage 46 and makes the first storage 45 store the work progress information thus read out (load the work progress information into the first storage 45).

According to the recovery processing, the recovery processor 495 reopens (recovers) the wireless communication with the tool 2 through the second communications unit 41.

Incidentally, the tool 2 operates with electricity stored in the battery pack 201, which is a power source different from a power source (the external power source AC1) of the control device 4. Therefore, the tool 2 can perform the tightening operation even during the power outage or reboot processing of the control device 4. When the tightening operation is performed, the tool 2 thus transmits the result information. However, the control device 4 cannot receive the result information during the power outage or the reboot processing. Therefore, if the tool 2 performs a tightening operation during the power outage or the reboot processing of the control device 4, then the work number of the work progress information held by the control device 4 may become different from the work number of the current status information held by the tool 2. For this reason, during the recovery processing after the recovery of the wireless communication, the recovery processor 495 receives the current status information from the tool 2 and compares the current status information thus received with the work progress information loaded into the first storage 45.

If the work number of the work progress information and the work number of the current status information agree to each other as a result of the comparison, then the recovery processor 495 finishes the recovery processing.

On the other hand, if the work number of the work progress information and the work number of the current status information disagree to each other as a result of the comparison, then the recovery processor 495 transmits a retransmission request to the tool 2 to request retransmission of the result information that the control device 4 could not have received. The retransmission request contains the work number of the result information for which the retransmission is requested. When receiving the retransmission request, the tool 2 transmits again, to the control device 4, the result information requested by the retransmission request. The recovery processor 495 generates the work progress information based on the result information thus received; makes the first storage 45 store it; transmits the result information to the master device 5 through the third communications unit 42; and makes the determiner 493 determine whether the work to be performed by the tool 2 is completed, based on the work progress information. Then the recovery processor 495 finishes the recovery processing.

After the recovery processor 495 finishes the processing, the re-indicator 496 transmits, to the tool 2 through the second communications unit 41, a revised work request which is the work request revised based on the work progress information stored in the second storage 46. Suppose an exemplary case where: the work request requesting to perform the tightening operations three times (i.e., the work request containing the number of work information of “3”) is transmitted to the tool 2; the power outage or the reboot processing occurs at a time when the result information containing the work number of “1” is received from the tool 2; and the work number contained in the work progress information and the work number contained in the current status information agrees to each other. In this case, the re-indicator 496 will transmit the work request containing the number of work information of “2” (i.e., revised work request) to the tool 2. This procedure can resume the work that has been performed before the power outage or the reboot.

According to the control device 4 and the tool system 1 including the same of the present embodiment, it is possible to avoid the work progress information from being lost and also to extend the service life of the second storage 46 as the non-volatile memory. Consequently, it is possible to improve the usability.

### (3) Operational Examples of Tool System

First to third Operational examples according to the tool system 1 of the present embodiment will be described. In the first to third operational examples below, it is supposed that the work request transmitted from the control device 4 to the tool 2 contains the number of tightening operations of “3” and the work parameter (target torque value) of “A1”.

### (3.1) First Operational Example

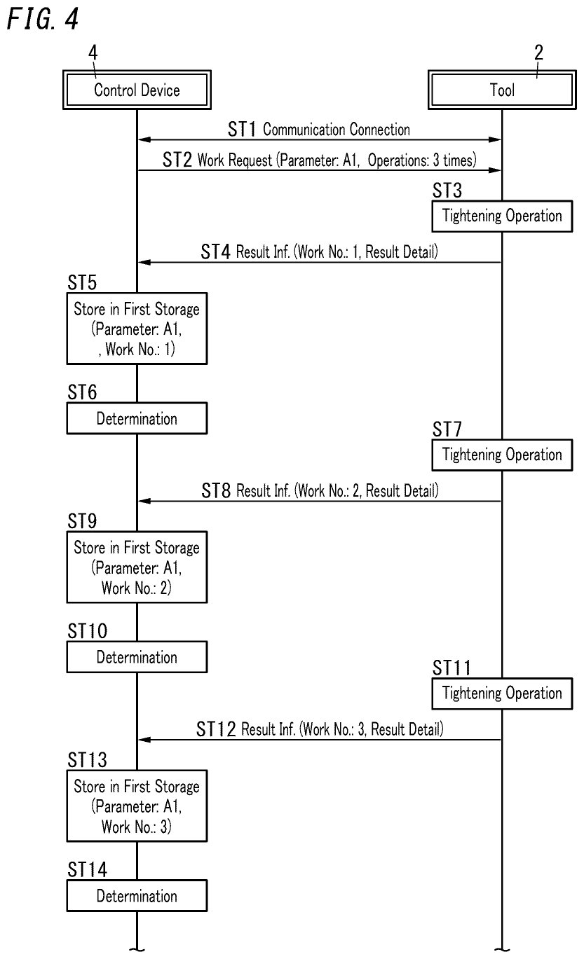

According to the first operational example, operations of the tool system 1 in a normal case where neither the power outage nor the reboot occurs during the work will be described with reference to FIG. 4.

Firstly, the tool 2 and the control device 4 are connected with each other via the wireless communications (ST1), and the control device 4 transmits the work request to the tool 2 (ST2). The control device 4 transmits the work request to the tool 2, in response to the transmission of the work instruction from the master device 5 to the control device 4 for example, although not shown in FIG. 4. Transmitting the work request, the work progress information containing the work number of “0”, which indicates the start of the work, is stored in the first storage 45 of the control device 4.

When receiving the work request, the tool 2 performs the first tightening operation, using the tightening unit 240 and with the work parameter (parameter: A1) based on the work request (ST3). The first communications unit 25 of the tool 2 transmits the result information containing the work number of “1” to the control device 4 (ST4).

Then, the control device 4 receives the result information containing the work number of “1”. The work number of “1” contained in the received result information is the number next to the work number of “0” contained in the work progress information stored in the first storage 45. Thus, the control device 4 updates the work progress information based on the received result information and makes the first storage 45 store the updated work progress information (ST5). Also, the control device 4 determines, by the determiner 493, whether the work is completed (ST6). In that case, since the work number contained in the work progress information is “1”, the determiner 493 determines that the work is not completed yet. Also, the control device 4 transmits the received result information from the third communications unit 42 to the master device 5.

Subsequently, the tool 2 performs the second tightening operation, using the tightening unit 240 and with the work parameter (parameter: A1) based on the work request (ST7). The tool 2 then transmits the result information containing the work number of “2” from the first communications unit 25 to the control device 4 (ST8).

The control device 4 receives the result information containing the work number of “2”. The work number of “2” contained in the received result information is the number next to the work number of “1” contained in the work progress information stored in the first storage 45. Thus, the control device 4 updates the work progress information based on the received result information and makes the first storage 45 store the updated work progress information (ST9). Also, the control device 4 determines, by the determiner 493, whether the work is completed (ST10). In that case, since the work number contained in the work progress information is “2”, the determiner 493 determines that the work is not completed yet. Also, the control device 4 transmits the received result information from the third communications unit 42 to the master device 5.

Furthermore, the tool 2 performs the third tightening operation, using the tightening unit 240 and with the work parameter (parameter: A1) based on the work request (ST11). The tool 2 then transmits the result information containing the work number of “3” from the first communications unit 25 to the control device 4 (ST8).

The control device 4 receives the result information containing the work number of “3”. The work number of “3” contained in the received result information is the number next to the work number of “2” contained in the work progress information stored in the first storage 45. Thus, the control device 4 updates the work progress information based on the received result information and makes the first storage 45 store the updated work progress information (ST13). Also, the control device 4 determines, by the determiner 493, whether the work is completed (ST14). In that case, since the work number contained in the work progress information is “3”, the determiner 493 determines that the work is completed. Then, the control device 4 transmits, from the third communications unit 42 to the master device 5, the received result information along with completion information indicative of the completion of the work. The control device 4 also transmits the work completion information to the tool 2.

### (3.2) Second Operational Example

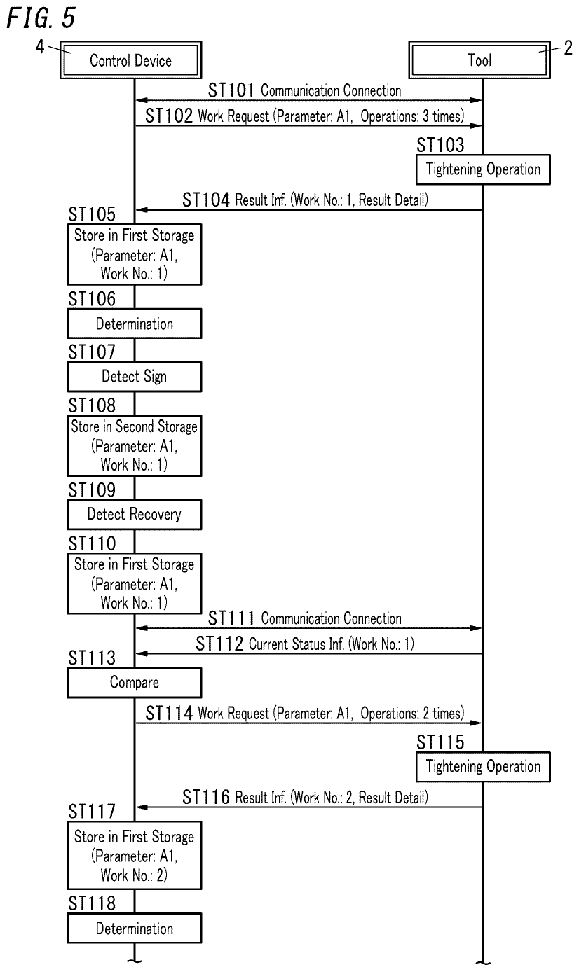

According to the operational examples 2 and 3, operations of the tool system 1 will be described in a case where the supply of the operating power to the first storage 45 is interrupted (i.e., a case where the power outage occurs or a case where the controller 49 executes the reboot processing) during the work performed by the tool 2. The second operational example will be described with reference to FIG. 5 which is a case where the tool 2 does not perform the tightening operation during the interruption of the supply of the operating power to the first storage 45.

Note that the steps ST101 to ST106 of the second operational example correspond to the steps ST1 to ST6 of the first operational example, descriptions thereof are omitted.

In this example, after the control device 4 receives the result information containing the work number of “1”, the detector 48 of the control device 4 detects the sign (power outage, or precursor of the reboot) (ST107).

When detecting the sign, the control device 4 makes, by the second storing processor 494, the second storage 46 store the work progress information (ST108). After then, the supply of the operating power to the first storage 45 is interrupted due to the power outage or the reboot, and the stored information is deleted from the first storage 45 and also the communication connection between the tool 2 and the control device 4 is lost.

Then, the control device 4 detects, by the recovery processor 495, the resumption of the supply of the operating power to the first storage 45 (i.e., detects the restoration of power or the completion of the reboot) (ST109).

In the control device 4, the work progress information stored in the second storage 46 is read out by the recovery processor 495 and then is made stored in (loaded into) the first storage 45 (ST110). Note that the work progress information stored in the second storage 46 may, after being read out by the recovery processor 495, be deleted from the second storage 46 or be held as it is, whichever is appropriate.

Then, the tool 2 and the control device 4 are again connected wirelessly (ST111). When the wireless communication is reopened (recovered), the tool 2 transmits the current status information to the control device 4 (ST112).

When receiving the current status information, the control device 4 compares the current status information thus received with the work progress information (ST113). According to the subject operational example, the tool 2 does not perform the tightening operation during the power outage or the reboot processing. Therefore, the work number of “1” contained in the current status information and the work number of “1” contained in the work progress information agree to each other. When confirming that the work numbers agree to each other, the control device 4 revises the work request based on the work progress information, and transmits the revised work request from the second communications unit 41 to the tool 2 (ST114).

When receiving the revised work request, the tool 2 resumes the work in accordance with the work request (ST115 and after). Note that operations after the step ST115 of the second operational example correspond to the operations after the step ST7 of the first operational example, descriptions thereof are omitted.

### (3.3) Third Operational Example

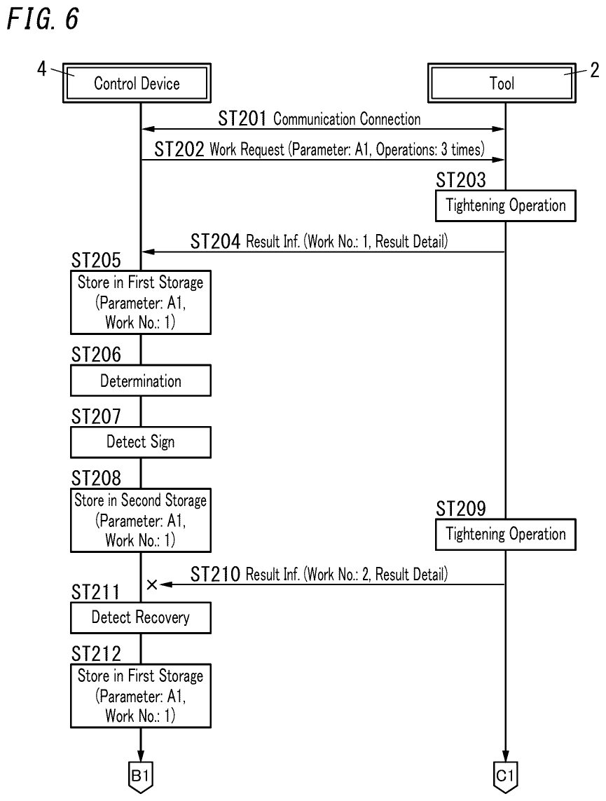

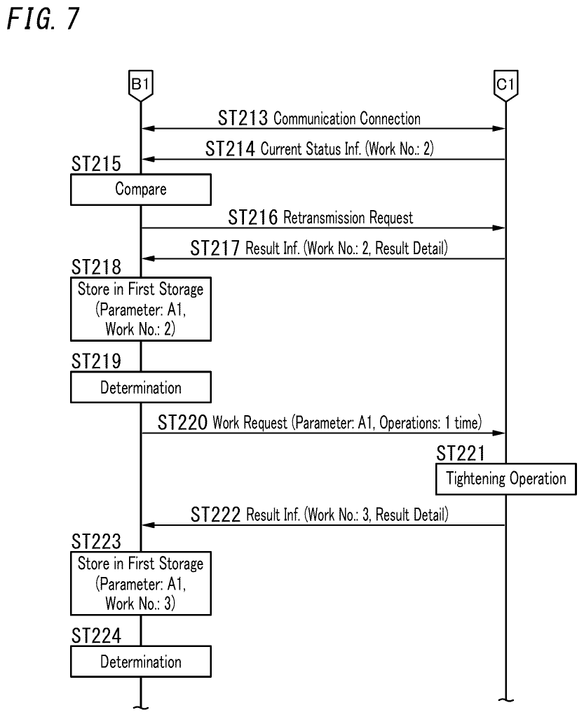

The third operational example will be described with reference to FIGS. 6 and 7 which is a case where the tool 2 performs the tightening operation one time during the interruption of the supply of the operating power to the first storage 45.

Note that the steps ST201 to ST208 of the third operational example correspond to the steps ST101 to ST108 of the second operational example, descriptions thereof are omitted.

According to the present operational example, the tool 2 performs the second tightening operation during the power outage or the reboot processing of the controller 49 (ST209). When performing the tightening operation, the tool 2 tries to transmit the result information to the control device 4. However, since the communication connection between the tool 2 and the control device 4 is lost, the control device 4 cannot receive the result information (ST210).

After then, the control device 4 detects, by the recovery processor 495, the resumption of the supply of the operating power to the first storage 45 (i.e., detects the restoration of power or the completion of the reboot) (ST211). The work progress information stored in the second storage 46 is then made stored in (loaded into) the first storage 45 (ST212).

Then, the tool 2 and the control device 4 are again connected wirelessly (ST213), and the tool 2 transmits the current status information to the control device 4 (ST214).

When receiving the current status information, the control device 4 compares the current status information thus received with the work progress information (ST215). According to the subject operational example, the tool 2 has performed the tightening operation during the power outage or the reboot processing. Therefore, the work number of “2” contained in the current status information and the work number of “1” contained in the work progress information disagree to each other. When confirming that the work numbers disagree to each other, the control device 4 requests the tool 2 to retransmit the result information containing the work number of “2” (ST216). When receiving the retransmission request, the tool 2 retransmits the result information containing the work number of “2” to the control device 4.

When receiving the result information containing the work number of “2”, the control device 4 updates the work progress information based on the result information thus received, and makes the first storage 45 store the updated work progress information (ST218). The control device 4 determines, by the determiner 493, whether the work is completed (ST219). Since the work is not completed yet, the control device 4 revises the work request based on the work progress information, and transmits, from the second communications unit 41 to the tool 2, the work request thus revised (ST220). When receiving the revised work request, the tool 2 resumes the work in accordance with the work request (ST221 and after). Note that operations after the step ST221 of the third operational example correspond to the operations after the step 11 of the first operational example, descriptions thereof are omitted.

### (4) Variation

The embodiment described above is only one of various embodiments of the present disclosure, and may be readily modified, changed, replaced, or combined with any other embodiments, depending on a design choice or any other factor, without departing from a true spirit and scope of the present disclosure. Variations of the embodiment described above will be enumerated one after another. Note that any of the variations to be described below may be combined as appropriate.

The controller 49 of the control device 4 according to the present disclosure includes a computer system. In that case, the computer system may include, as principal hardware components, a processor and a memory. The functions of the controller 49 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very large-scale integrated circuit (VLSI), and an ultra large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be integrated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a largescale integrated circuit.

Also, in the embodiment described above, the plurality of constituent elements (or the functions) of the controller 49 are integrated together in a single housing. However, this is only an example and should not be construed as limiting. Alternatively, those constituent elements (or functions) of the controller 49 may be distributed in multiple different housings. Conversely, the plurality of functions of the controller 49 may be integrated together in a single housing. Still alternatively, at least some functions of the controller 49 may be implemented as a cloud computing system as well.

### (4.1) First Variation

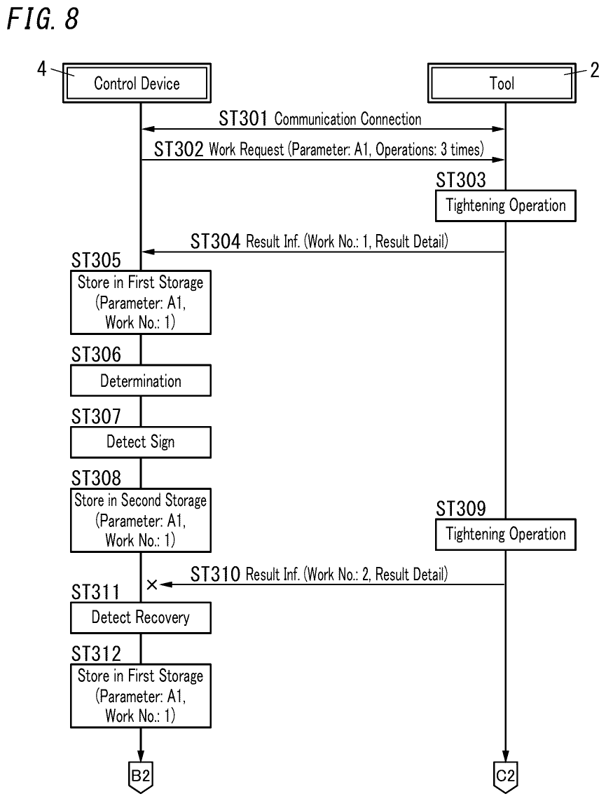

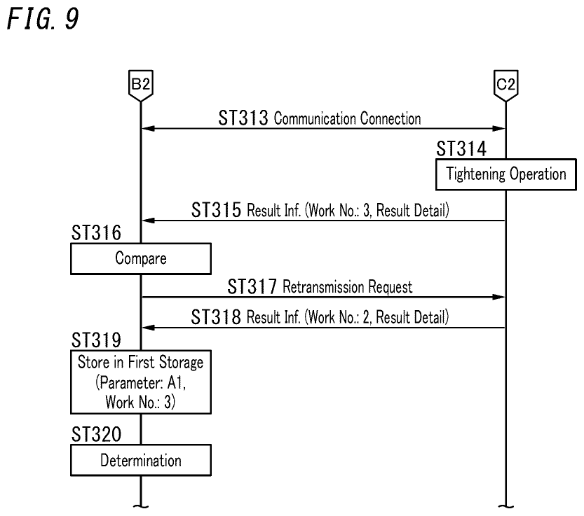

A tool system 1 according to the present variation differs from the tool system 1 according to the embodiment mainly in that the tool 2 does not transmit the current status information when the communication is reopened. The tool system 1 according to the present variation will be described with reference to FIGS. 8 and 9.

FIGS. 8 and 9 show an operational example of the tool system 1 according to the present variation. Note that the steps ST301 to ST313 of the operational example according to the present variation shown in FIGS. 8 and 9 correspond to the steps ST201 to ST213 of the third operational example according to the embodiment, descriptions thereof are omitted.

According to the present variation, after the reopen of the communication (ST313), the tool 2 performs the next (third) tightening operation (ST314) without transmitting the current status information, and then transmits the result information to the control device 4 (ST315).

When receiving the result information, the control device 4 compares the result information thus received with the work progress information loaded into the first storage 45 (ST316). According to the present operational example, the work number of “3” contained in the received result information does not the number next to the work number of “1” contained in the work progress information stored in the first storage 45. Therefore, the control device 4 determines that there is missing result information (i.e., there is result information that the control device 4 cannot receive). The control device 4 requests the tool 2 to retransmit the not-received result information (i.e., the result information containing the work number of “2”) (ST317). The tool 2 retransmits the result information in response to the retransmission request (ST318). Note that operations after the step ST319 of the operational example according to the present variation correspond to the operations after the step ST223 of the third operational example according to the embodiment, descriptions thereof are omitted.

### (4.2) Other Variations

In one variation, the tool 2 is not limited to a configuration where the work unit 24 includes the tightening unit 240. Alternatively, the tool 2 may be a cutting tool (such as a circular saw) where the work unit 24 includes a cutting unit, or may be a grinder where the work unit 24 includes a grinding unit, for example.

In one variation, the second storing processor 494 may be configured to make the second storage 46 store the work progress information without reading out the work progress information from the first storage 45. The second storing processor 494 may be configured to generate the work progress information by using the result information that the second communications unit 41 receives last time, and makes the second storage 46 store the work progress information thus generated.

In a tool system 1 of one variation, the control device 4 may be configured to not transmit the work request to the tool 2. For example, the tool 2 may be configured to repeat operations of the “work request” preliminarily stored in the tool-end storage 26.

In one variation, the tool 2 may be configured to be inhibited from performing the work operation (tightening operation) when the communication connection with the control device 4 is lost. In this case, the tool 2 cannot perform the tightening operation when the tool 2 cannot transmit the result information. It is therefore possible to reduce the possibility that the current status information of the tool 2 and the work progress information of the control device 4 differ from each other as described in the third operational example.

In one variation, the control device 4 may be configured to transmit, to the tool 2, an acknowledgement (ACK) in reply to the reception of the result information from the tool 2. In this case, the tool 2 may be inhibited from performing the next work operation (tightening operation) until receiving the acknowledgement. The tool 2 may repeat sending the result information at regular intervals until receiving the acknowledgement. Also in this case, it is possible to reduce the possibility that the current status information of the tool 2 and the work progress information of the control device 4 differ from each other as described in the third operational example.

In one variation, the work request transmitted from the second communications unit 41 may contain one or more work operations sequentially performed based on the same work parameter, among multiple work operations to be performed by the tool 2. In other words, work operations performed based on different work parameters may be transmitted by mutually different work requests. With this configuration, it is possible to divide the work parameters into small groups and to transmit the small groups at different timings, which can shorten the time for one transmission, compared to a case where various work parameters are collectively transmitted at one time. According to this variation, the tool 2 can start the work immediately.

### (5) Aspect

As described above, a control device (4) of a first aspect includes a second communications unit (41), a first storage (45), a first storing processor (492), a regular power supply unit (471), a detector (48), a second storage (46), and a second storing processor (494). The second communications unit (41) is configured to receive result information transmitted from a tool (2). The tool (2) includes a first communications unit (25) configured to transmit the result information that depends on progress of a work. The first storage (45) is a volatile memory. The first storing processor (492) is configured to make the first storage (45) store work progress information. The work progress information is information based on the result information and indicative of a state of progress of the work. The regular power supply unit (471) is configured to be supplied with external power from an external power source (AC1) through a power line and to supply, using the external power, operating power to the first storage (45). The detector (48) is configured to detect a sign of an interruption of a supply of the operating power from the regular power supply unit (471) to the first storage (45). The second storage (46) is a non-volatile memory. The second storing processor (494) is configured to, when the detector (48) detects the sign, make the second storage (46) store the work progress information.

According to this aspect, it is possible to avoid the work progress information from being lost and also to extend the service life of the second storage (46) as the non-volatile memory. Consequently, it is possible to improve the usability.

The control device (4) of a second aspect, realized in combination with the first aspect, further includes an emergency power supply unit (472) configured to receive emergency power from an emergency power source (470) which is different from the external power source (AC1). The detector (48) includes a power outage detector (481) configured to detect, as the sign, a power outage which is an interruption of a supply of the external power from the external power source (AC1). The second storing processor (494) is configured to, when the power outage detector (481) detects the power outage, operate with the emergency power and make the second storage (46) store the work progress information.

According to this aspect, it is possible to avoid the work progress information from being lost during the power outage and also to extend the service life of the second storage (46) as the non-volatile memory. Consequently, it is possible to improve the usability.

In the control device (4) of a third aspect, realized in combination with the second aspect, the emergency power supply unit (472) is configured to, before the second storing processor (494) performs a processing to make the second storage (46) store the work progress information, stop supplying operating power to the second communications unit (41).

This aspect can reduce the consumption of the emergency power to increase the possibility for the second storing processor 494 to complete the processing.

In the control device (4) of a fourth aspect, realized in combination with the first to third aspects, the detector (48) includes a reboot detector (482) configured to detect, as the sign, a precursor of a reboot of a controller (49) including the first storing processor (492). The second storing processor (494) is configured to, when the reboot detector (482) detects the precursor of the reboot, make the second storage (46) store the work progress information.

According to this aspect, it is possible to avoid the work progress information from being lost during the reboot processing and also to extend the service life of the second storage (46) as the non-volatile memory. Consequently, it is possible to improve the usability.

In the control device (4) of a fifth aspect, realized in combination with the first to fourth aspects, the second storing processor (494) is configured to, when the detector (48) detects the sign, read out the work progress information from the first storage (45) and make the second storage (46) store the work progress information thus read out.

According to this aspect, it is possible to perform the processing for making the second storage (46) store the work progress information without waiting the transmission of the result information from the tool (2). The work progress information thus can be surely saved in backup.

The control device (4) of a sixth aspect, realized in combination with the first to fifth aspects, further includes a request indicator (491) configured to transmit, to the tool (2) through the second communications unit (41), a work request indicative of contents of the work to be performed by the tool (2). The work request contains information about multiple work operations contained in the work, and information about a work parameter with which the tool (2) operates when the tool (2) performs each of the multiple work operations.

This aspect can improve the usability.

In the control device (4) of a seventh aspect, realized in combination with the sixth aspect, the result information contains a work number which indicates what is an ordinal number of work operation that has just finished among the multiple work operations.

This aspect can improve the usability.

The control device (4) of an eighth aspect, realized in combination with the sixth or seventh aspect, further includes a re-indicator (496). The re-indicator (496) is configured to, when finding that the supply of the operating power to the first storage (45) is resumed, transmit, to the tool (2) through the second communications unit (41), a revised work request which is the work request revised based on the work progress information stored in the second storage (46).

This aspect can improve the usability.

A tool system of a ninth aspect includes the control device (4) of any one of the first to eights aspects, and the tool (2).

This aspect can improve the usability.

### REFERENCE SIGNS LIST

1 Tool System
2 Tool
25 First Communications Unit
4 Control Device
41 Second Communications Unit
45 First Storage
46 Second Storage
470 Emergency Power Source
471 Regular Power Supply Unit
472 Emergency Power Supply Unit
48 Detector
481 Powe Outage Detector
482 Reboot Detector
49 Controller
491 Request Indicator
492 First Storing Processor
494 Second Storing Processor
496 Re-indicator
AC1 External Power Source

1. A control device comprising:
a second communications unit configured to receive result information transmitted from a tool, the tool including a first communications unit configured to transmit the result information that depends on progress of a work;
a first storage which is a volatile memory;
a first storing processor configured to make the first storage store work progress information, the work progress information being information based on the result information and indicative of a state of progress of the work;
a regular power supply unit configured to be supplied with external power from an external power source through a power line and to supply, using the external power, operating power to the first storage;
a detector configured to detect a sign of an interruption of a supply of the operating power from the regular power supply unit to the first storage;
a second storage which is a non-volatile memory; and
a second storing processor configured to, when the detector detects the sign, make the second storage store the work progress information.

2. The control device of claim 1, further comprising an emergency power supply unit configured to receive emergency power from an emergency power source which is different from the external power source, wherein
the detector includes a power outage detector configured to detect, as the sign, a power outage which is an interruption of a supply of the external power from the external power source, and
the second storing processor is configured to, when the power outage detector detects the power outage, operate with the emergency power and make the second storage store the work progress information.

3. The control device of claim 2, wherein
the emergency power supply unit is configured to, before the second storing processor performs a processing to make the second storage store the work progress information, stop supplying operating power to the second communications unit.

4. The control device of claim 1, wherein
the detector includes a reboot detector configured to detect, as the sign, a precursor of a reboot of a controller including the first storing processor, and
the second storing processor is configured to, when the reboot detector detects the precursor of the reboot, make the second storage store the work progress information.

5. The control device of claim 1, wherein
the second storing processor is configured to, when the detector detects the sign, read out the work progress information from the first storage and make the second storage store the work progress information thus read out.

6. The control device of claim 1, further comprising a request indicator configured to transmit, to the tool through the second communications unit, a work request indicative of contents of the work to be performed by the tool, wherein
the work request contains
information about multiple work operations contained in the work, and
information about a work parameter with which the tool operates when the tool performs each of the multiple work operations.

7. The control device of claim 6, wherein the result information contains a work number which indicates what is an ordinal number of work operation that has just finished among the multiple work operations.

8. The control device of claim 6, further comprising a re-indicator configured to, when finding that the supply of the operating power to the first storage is resumed, transmit, to the tool through the second communications unit, a revised work request which is the work request revised based on the work progress information stored in the second storage.

9. A tool system, comprising:
the control device of claim 1; and
the tool.
